(19) United States
(12) Patent Application Publication
(10) Pub. No.: US 2014/0279453 A1
(43) Pub. Date: Sep. 18, 2014

(54) Bill Payment Using Check Image

(71) Applicant: BANK OF AMERICA CORPORATION, Charlotte, NC (US)

(72) Inventors: William Blake Belchee, Charlotte, NC (US); Aditya Bhasin, Charlotte, NC (US); Laura C. Bondesen, Charlotte, NC (US); Matthew A. Calman, Charlotte, NC (US); David Godsman, Charlotte, NC (US); Cherie Rexroth, Magnolia, TX (US)

(73) Assignee: BANK OF AMERICA CORPORATION, Charlotte, NC (US)

(21) Appl. No.: 13/836,379

(22) Filed: Mar. 15, 2013

(51) Int. Cl. G06Q 20/10; G06Q 20/02; G06Q 20/32

(52) U.S. Cl. CPC G06Q 20/102; G06Q 20/32; G06Q 20/023
USPC 705/40

(57) ABSTRACT

Aspects herein describe at least a new method, system, and computer readable storage media for facilitating bill payment by way of using an image of a check. A computing system may transmit a bill payment request to a wireless computing device associated with an account holder of a bill payment account. The computing system may determine whether an account holder of the bill payment account holds a funding account held at the first organization, and as a result, may transmit a request to the wireless computing device for an image of a check associated with a second organization when the account holder of the bill payment account does not hold a funding account at the first organization. Bill payment may be made by way of an ACH transaction using a routing number and an account number obtained from the image of the check.

### FIELD

Generally, aspects of the disclosure relate to payment of a bill electronically using an image of a check captured by a computing device.

### BACKGROUND

Many financial institutions deliver their credit card bills over the mail. Often, the payer will place the bill into a stack of other bills for eventual payment. After opening the envelope, the payer of the credit card bill may write a check to make a payment. The payer may place the signed check into an envelope, apply the appropriate postage onto the envelope, and mail the envelope to the financial institution.

Thus, the process of making a payment may be time consuming and inconvenient. In addition, the payment may arrive late and the payer may be subject to a late payment fee.

### SUMMARY

In light of the foregoing background, the following presents a simplified summary of the present disclosure in order to provide a basic understanding of some aspects described herein. This summary is not an extensive overview, and is not intended to identify key or critical elements or to delineate the scope of the claims. The following summary merely presents various described aspects in a simplified form as a prelude to the more detailed description provided below.

In order to address the above shortcomings and additional benefits that will be realized upon reading the disclosure, aspects herein describe new methods and systems for facilitating bill payment of a credit account by way of using an image of a check.

Aspects described herein provide methods, systems, and computer-readable storage media for generating a bill payment request associated with a bill payment account held at a first organization in which the bill payment request comprises a remittance coupon specifying a balance due amount, transmitting the bill payment request to a wireless computing device associated with an account holder of the bill payment account, determining whether the account holder of the bill payment account holds a funding account (e.g., direct deposit) at the first organization, and transmitting a request for an image of a face of a check in response to a determination that the account holder of the bill payment account does not hold a funding account at the first organization. The method further includes receiving an electronic image of the face of a check in which the check corresponds to a funding account held at a second organization, extracting a routing number and an account number from a MICR line of the electronic image, and processing an ACH transaction between the first organization and the second organization using the routing number and the account number to pay at least a portion of the balance due amount.

The various aspects of the illustrative embodiments are substantially shown in and/or described in connection with at least one of the following figures, as set forth more completely in the claims.

These and other advantages, aspects, and novel features of the present disclosure, as well as details of illustrated embodiments, thereof, will be more fully understood from the following description and drawings.

### BRIEF DESCRIPTION OF THE DRAWINGS

Having thus described aspects of the disclosure in general terms, reference will now be made to the accompanying drawings, which are not necessarily drawn to scale, and wherein:

FIG. 1 illustrates an operating environment in which various aspects of the disclosure may be implemented.

FIG. 2A is a flow diagram of a method in accordance with various embodiments.

FIG. 2B is a flow diagram of a method in accordance with various embodiments.

### DETAILED DESCRIPTION

In the following description of the various embodiments, reference is made to the accompanying drawings, which form a part hereof, and in which is shown by way of illustration various embodiments in which aspects described herein may be practiced. It is to be understood that other embodiments may be utilized and structural and functional modifications may be made without departing from the scope and spirit of the present disclosure.

Various aspects described herein may be embodied as a method, a data processing system or apparatus, or a computer program product. Accordingly, those aspects may take the form of an entirely hardware embodiment, an entirely software embodiment, or an embodiment combining software and hardware aspects. Furthermore, such aspects may take the form of a computer program product stored in one or more non-transitory computer-readable storage media having computer-readable program code, or instructions, embodied in or on the storage media. Any suitable computer readable storage media may be utilized, including magnetic hard disk drives, optical discs such as CDs and DVDs, and/or other optical media or optical drives, NAS (network attached storage) devices, and/or any combination thereof. In addition, various signals, such as one or more digital signals, may comprise data (uncoded, coded, or encrypted) that may be transmitted between computing devices. The computing devices may comprise a digital appliance such as a smart television (TV), a desktop computer, laptop computer, and one or more portable wireless computing devices (e.g., a smartphone, cellphone, PDA, notebook, notepad), or any kind of computing device comprising a processor and memory which is capable of executing firmware and/or software.

As a general introduction to the subject matter described in more detail below, aspects herein provide methods, systems, and computer readable media for facilitating payment of a bill associated with a bill payment account by way of using an image of a check. A remittance coupon or slip may be transmitted by a financial institution to a payer or customer of the financial institution. The remittance coupon may comprise data or information that may be transmitted in a message to the customer. The message may comprise an e-mail message, text message, voice mail message, or any other message transmitted from the financial institution to the customer's wireless communication device. The payer may view the message which may comprise the remittance coupon or slip. The message may be displayed using a computing device, such as a wireless communication device. The payer may make a payment by capturing and attaching an image of a check associated with a direct deposit account held at another financial institution, and transmitting the image of the check back to the financial institution submitting the remittance coupon or slip.

In one embodiment, the payer has a bill payment account (e.g., corresponding to a credit card account) at a financial institution but does not also hold a direct deposit account at the same financial institution. In order to pay the bill, the payer may provide an image of a check associated with a direct deposit account (DDA) from a second financial institution. Otherwise, if the payer of the bill holds a DDA with the same financial institution providing the bill payment account, the bill payment may be made by way of an internal funds transfer using a server or computing device of the financial institution.

In one embodiment, a funding account from the second financial institution may be established electronically at the financial institution holding the bill payment account to automate future bill payment transactions. The funding account may be established to obviate the need to resubmit the image of the check and to reprocess the image of the check repeatedly for any future bill payment transactions associated with the bill payment account.

In one embodiment, the wireless communication device comprises wireless phone, notepad, notebook, and the like. The wireless communication device may comprise a camera which is used to capture and transmit an image of the face of a check to the financial institution that provides a credit account to the payer and/or services the bill payment account.

FIG. 1 is a block diagram of a suitable computing system environment 100 that may be used to provide bill processing for one or more customers associated with one or more bill payment accounts, in accordance with an exemplary embodiment. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The computing system environment 100 comprises a computing system 101, one or more wireless computing devices 140, and one or more computing devices 142. The one or more computing devices 140 may comprise one or more personal computers capable of communicating with the Internet by way of a wide area network (WAN) connection. The one or more wireless computing devices 140 may comprise a mobile telephone, smartphone, or any other handheld device capable of wireless communication using protocols such as Wi-Fi, Bluetooth, and the like. The one or more wireless computing devices 140 and the one or more computing devices 142 may comprise a camera capable of taking close-up pictures of a check.

The computing system 101 may include, but is not limited to, one or more personal computers (PCs), one or more server computers (i.e., servers), one or more hand-held or laptop devices, one or more multiprocessor systems, one or more microprocessor-based systems, one or more network PCs, one or more minicomputers, one or more mainframe computers, one or more distributed computing environments that include any of the above systems or devices, and the like. The computing system 101 may comprise a server at the financial institution or financial organization, such as a bank or credit union, for example.

The computing system environment 100 includes a computing system 101 wherein the processes discussed herein may be implemented. The computing system 101 may comprise a server having a processor 103 for controlling overall operation of the computing system 101 and its associated components, including random-access memory (RAM) 105, read-only memory (ROM) or non-volatile memory 107, communications input/output module 109, and memory 115. Processor 103 and its associated components may allow the computing system 101 to execute a series of computer-readable instructions related to generating and transmitting a bill payment request to the computing devices 140, 142, in which the bill payment request may include a balance due amount. Among other things, the processor 103 and its associated components may allow the computing system 101 to execute a series of computer-readable instructions related to a method for receiving an electronic image of a face of a check and extracting data corresponding to a MICR (magnetic ink character recognition) line on the face of the check, identifying one or more characters of said MICR line, determining a direct deposit account corresponding to the one or more characters, and determining whether the direct deposit account associated with the MICR line is held at the organization. Furthermore, the method may include electronically transferring funds from said direct deposit account to said credit account to pay said balance when said direct deposit account is held at said first organization and may include processing an ACH transaction to pay said balance when said account is held at a second organization.

The one or more applications 119 may comprise the previously described computer-readable instructions executed by the processor 103. The one or more applications 119 may be stored in the memory 115 and may be executed by the processor 103.

Processor 103 may also direct computing system 101 to interact and communicate with one or more wireless computing devices 140 and one or more computing devices 142. The devices 140, 142 may comprise client devices for running one or more client applications under direction of the computing system 101. The one or more devices 140, 142 may be used to capture and communicate check images from a customer to the financial institution. In some aspects, the one or more devices 140, 142 may be used to receive information concerning a transaction associated with an account such as a bill payment account.

The computer-readable instructions stored in the RAM 105 or the memory 115 may be executed by the processor 103. A user or operator of the computing system 101 and/or devices 140, 142 may provide input data and/or commands for running the one or more applications 119. The input data may be used by the processor to control the execution of the computer-executable instructions stored in memory 115. The input data may also be stored in memory 115 or in a data storage device 121. While FIG. 1 may illustrate the one or more applications 119 as being resident in the memory 115, alternatively, the one or more applications 119 may also be resident within a data storage device (not shown) of each of the devices 140, 142. The memory 115 and/or data storage device 121 may comprise one or more drives, such as one or more portable hard disk drives, for example.

The random access memory (RAM) 105 may store data used by the one or more applications while the computing system 101 is executing the computer-executable instructions by the processor 103. The non-volatile memory or read-only memory (ROM) 107 may store data which is regularly used by the operating system 117. The operating system 117 may be stored in the memory 115.

Computing system 101 typically includes a variety of computer readable media. Computer readable media may be any available media that may be accessed by computing device 101 and may include both volatile and nonvolatile media, removable and non-removable media. By way of example, and not limitation, the computer-readable media may comprise a combination of computer storage media and communication media. The memory 115 and/or data storage device 121 may comprise computer readable media. The computer readable media may comprise one or more hard disk drives, for example. The computing system 101 may be owned and/or operated by the financial organization at which the viewer's bank accounts are located. Computer readable media may be implemented in any method or technology for storage of information such as computer readable instructions, data structures, program modules, or other data. Computer readable media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store desired information that can be accessed by the computing system 101 or devices 140, 142.

Communications input/output module 109 may include a microphone, keypad, touch screen, and/or stylus through which a user of computing system 101 may provide input, and may also include one or more speakers for providing audio output and a video display device for providing textual, audiovisual and/or graphical output.

Computing system 101 may operate in a networked environment supporting connections to one or more remote computing devices, such as computing devices 140, 142. Each of the devices 140, 142 may include many or all of the elements described with regard to computing system 101.

The network connections depicted in FIG. 1 include wide area networks (WANs) 129 but may also include any other types of networks. When used in a WAN networking environment, the computing system 101 may include a modem in the communications module 109 or other means for establishing communications over the WAN 129 by way of the WAN interface 127. It will be appreciated that the network connections shown are illustrative and other means of establishing a communications link between the computing devices may be used. Various well-known protocols such as TCP/IP, Ethernet, FTP, HTTP and the like may be used, and the computing system 101 may be operated in a client-server configuration.

The one or more application programs 119 used by the computing system 101, according to an illustrative embodiment, may include computer-executable instructions for invoking user functionality related to communications including, for example, email, short message service (SMS), downloading and using web based applications. In addition, the application programs 119 may include computer-executable instructions for invoking one or more of the functions, steps, and/or processes described in FIGS. 2-4.

Although not required, various aspects of the invention, as described herein, may be embodied as a method, a computing system, or as a non-transitory computer-readable media storing computer-executable instructions. For example, a computer-readable media may store instructions that, when executed by one or more processors, causes an apparatus or system to perform steps of a method or process in accordance with aspects of the disclosed embodiments. For example, aspects of the method steps disclosed herein may be executed on a processor 103 resident in the computing system 101. Such a processor may execute computer-executable instructions stored on a computer-readable media.

As illustrated, a cellular tower or repeater 144 may be used to communicatively couple the wireless computing device 140 to the computing system 101. The cellular tower 144 may be connected to the Internet 130 as shown in FIG. 1.

FIGS. 2A and 2B illustrate a method in accordance with various embodiments. The flowchart of FIGS. 2A and 2B may be implemented, for example, using aspects of the system described in connection with FIG. 1.

At step 204, a computing device or wireless computing device, such as one or the one or more computing devices or wireless computing devices described in connection with FIG. 1, may be used to electronically receive a bill associated with an account. The account may correspond to any type of credit account in which a financial institution provides credit to a person. For example, the account may comprise a credit card account associated with a credit card issued by a financial institution. In other embodiments, the account may comprise any other type of credit account, such as a mortgage, loan, insurance, utility, or service account, for example.

The bill may comprise a payment coupon, remittance coupon, or remittance slip electronically transmitted by a financial institution. The remittance coupon or slip may identify the payer's name and the account number associated with the bill payer. The coupon or slip may also identify an amount due, payment due date, and the like. The financial institution may electronically transmit the coupon or slip to a wireless computing device associated with the bill payer. The coupon or slip may be incorporated into an e-mail message sent to the payer. The payer may execute an application on the wireless computing device to facilitate viewing of the coupon or the information provided by the coupon. The application may be downloaded by the payer for use by the payer's wireless computing device. The application may be provided by the financial institution and may be downloaded from a computing device or server resident at the financial institution.

At step 208, a computing device or server at the financial institution may determine whether the payer is an account holder of a funding account held at the financial institution associated with the bill (such as a direct deposit account). For example, the server may search a database in one or more storage devices using information associated with the account holder, such as the account holder's name, phone number, social security number, and the like, to determine whether the account holder holds a direct deposit account at the associated financial institution. The account holder may be an account owner of the account associated with the bill. If the payer has a direct deposit account at the same institution as the account associated with the bill, the process proceeds with step 212. Otherwise, if the payer is not an account holder of a direct deposit account at the same institution as the bill, the process commences with step 228. In some aspects, the payer may be described as a “single product customer” having established only a single credit account, such as a credit card account, with the financial institution. Use of the term “single product customer” may describe that the payer is an account holder of a single credit related account, such as a single credit card account. When an account holder is a “single product customer,” aspects of the disclosure set forth in steps 228, 232, 236, 240, 244, 248, 252, 256, 260 may be used because the payer does not hold a funding account (e.g., a DDA) in the same financial institution from which to fund payment of a bill associated with the credit related account, as was described in steps 212, 216, 220, 224.

At step 212, a direct deposit account may be identified by the server at the financial organization. The payer may be directed to a link that accesses account related data over a secure website. At the website, one or more direct deposit accounts may be displayed along with the remittance coupon or other information associated with the bill. The website may provide pull-downs or tabs in which to perform a transfer of funds from the DDA to the account associated with the bill. The website may allow the payer to input a desired amount corresponding to a portion or all of the balance due which is indicated on the remittance coupon. When the payer holds multiple direct deposit accounts, the payer may be able to select a particular DDA from which funds will be used to pay the bill. The website may allow scheduling of a payment at a date specified by the payer.

At step 216, the payer may make a payment by performing a real time transfer of funds from the selected direct deposit account. For example, the payer may depress or select a button on the touch-screen of a computing device, such as a wireless computing device, to perform the real time transfer or withdrawal of funds.

At step 220, the financial institution may report the transfer of funds from a direct deposit account to the payer. The financial institution may transmit a message, such as an e-mail message to an e-mail address of the payer that a transfer of funds has occurred from the direct deposit account of the payer. A transaction confirmation including the amount of the transfer and the date/time of the transfer may be specified in the e-mail message. The financial institution may also mail a transaction confirmation of the transfer or withdrawal to the payer by mail. A device, such as the one or more computing device or wireless computing devices described in connection with FIG. 1, may be used to receive and view the transaction confirmation.

At step 224, the financial institution may report that a bill payment has occurred. The financial institution may transmit a message, such as an e-mail message to an e-mail address of the payer that payment has occurred. A bill payment transaction confirmation including the amount of payment and the date/time of payment may be specified in the e-mail message. The financial institution may also mail a bill payment transaction confirmation of the bill payment to the payer by mail. A device, such as the one or more computing devices or wireless computing devices described in connection with FIG. 1, may be used to receive and view the bill payment transaction confirmation.

At step 228, the payee (financial institution associated with the credit card account) may request an image of a check corresponding to a checking account held at another financial institution. The checking account may be used to fund the payment. The request may be sent to a wireless computing device associated with an account holder of the bill payment account. The payer may prepare a check specifying a desired amount for payment to the payee. The desired amount may correspond to the balance specified in the remittance coupon. The desired amount may also correspond to a portion of the balance specified in the remittance coupon. The check may correspond to one of one or more direct deposit accounts held by the payer at one or more other financial institutions. After specifying the amount of payment on the check, the payer may sign and date the check.

At step 232, the payer may capture an image of the face of the prepared check. For example, the image may be captured using a camera provided by the payer's wireless computing device. In one embodiment, the payer may capture at least the MICR (magnetic ink character recognition) line of the check. The MICR line may be used by a computing device to process the transfer of funds from the financial institution associated with the DDA to the financial institution associated with the credit or bill payment account. In one embodiment, the wireless computing device may execute an application that verifies the quality of the characters in the MICR line of the captured image. The application may indicate whether the image quality of the MICR line is acceptable or unacceptable. If the image quality is determined to be unacceptable, additional images may be captured by the camera of the wireless computing device until the image quality is acceptable.

At step 236, the image of the check may be transmitted back to the financial institution from the wireless computing device. The image may be transmitted to a server or computing device of the financial organization providing the credit card to the payer. In some aspects, the image may be uploaded to a server of the financial organization through a website. The application provided by the financial institution may facilitate uploading of the image to the server.

At step 240, the server at the financial institution (associated with the credit card account) may process the image it receives to extract MICR data associated with the check. The server may scan the check image in certain fields or portions of the check to identify the payer's name, check number, date, signature, and the MICR line on the face of the check. The server may verify the information on the check for accuracy. For example, the server may verify whether the amounts written on the check correspond to the amount specified in the remittance coupon or slip. If the amount written on the check exceeds the amount specified in the coupon or slip, the server may disable further processing of the bill payment until the payer resubmits a replacement check, for example. The server may verify whether the check was signed. If the check has not been signed, the server may disable further processing of the bill payment until the payer resubmits an image of a replacement check, for example. An application on the server may process the MICR line image using optical character recognition (OCR) to digitize each character of the MICR line.

At step 244, the digitized characters of the MICR line may be used to identify the checking account or direct deposit account associated with the check. For example, the data obtained from optical character recognition of the MICR line may be used to determine a routing number, account number, and check number of the payer bank associated with the check. The payer's name, address, check number, date, signature, and any other information may be collected and stored by the server at the financial institution associated with the credit card or bill payment account.

Next, the process proceeds with step 248 of FIG. 2B, in which the financial institution associated with the account may perform an accounts receivable conversion (ARC) using the image of the check. The check may undergo an accounts receivable conversion after the routing number and account number is determined from the MICR line of the check image.

At step 252, by way of performing an accounts receivable conversion, the check may be processed electronically as an ACH (automated clearing house) transaction over the ACH network. Accounts receivable conversions for a number of checks may be collected and sent as a batch file for processing over the ACH network. Thus, bill payment may occur by way of an ARC over the ACH network.

At step 256, after ACH payment processing has occurred, the financial institution may report that a bill payment transaction has occurred for the account associated with the bill. The financial institution may transmit a message, such as an e-mail message to an e-mail address of the payer that indicates the payment has occurred. A bill payment transaction confirmation including the amount of payment and the date/time of payment may be specified in the e-mail message. The financial institution may also mail a bill payment transaction confirmation to the payer by mail. A device, such as one of the one or more computing devices or wireless computing devices described in connection with FIG. 1, may be used to receive and view the bill payment transaction confirmation.

At step 260, an external funding account may be established for the payer using the data obtained from the image of the check. The routing number and account number may be used to configure the external funding account associated with the checking account. The external funding account may be used to automate the bill payment process in the future should the payer wish to use the same checking account to pay another bill associated with the credit card account.

The foregoing presents a simplified summary of the disclosure in order to provide a basic understanding of some aspects. It is not intended to identify key or critical elements of the invention or to delineate the scope of the invention. Although not required, the various aspects described herein may be embodied as a method, a data processing system, or as a non-transitory computer-readable medium for storing computer-executable instructions that are capable of being executed by a processor of a computer system. Aspects of the invention have been described in terms of illustrative embodiments thereof. Numerous other embodiments, modifications, and variations within the scope and spirit of the disclosed invention are possible from a review of this entire disclosure. For example, the steps illustrated in the illustrative figures may be performed in other than the recited order, and that one or more steps illustrated may be optional in accordance with aspects of the disclosure. While some embodiments have been described with respect to specific examples, other embodiments include numerous variations and permutations of the above described systems and techniques.

Although the subject matter has been described in language specific to structural features and/or methodological acts, it is to be understood that the subject matter defined in the appended claims is not necessarily limited to the specific features or acts described above. Rather, the specific features and acts described above are disclosed as illustrative forms of implementing the claims.

What is claimed is:

1. A computing system comprising:
at least one processor; and
at least one memory for storing computer executable instructions, wherein execution of said computer executable instructions by said at least one processor causes said computing system to perform:
generating a bill payment request associated with a bill payment account held at a first organization, said bill payment request comprising a balance due amount;
transmitting said bill payment request to a wireless computing device associated with an account holder of said bill payment account;
determining whether said account holder of said bill payment account holds a funding account at said first organization;
transmitting a request for an image of a face of a check in response to a determination that said account holder of said bill payment account does not hold said funding account at said first organization;
receiving an electronic image of said face of a check wherein said check corresponds to a funding account held at a second organization;
extracting a routing number and an account number from said electronic image; and
processing a transaction using said routing number and said account number to pay at least a portion of said balance due amount, said transaction occurring between said first organization and said second organization.

2. The system of claim 1 wherein:
said electronic image is generated by said wireless communication device.

3. The system of claim 1 wherein said extracting includes using optical character recognition (OCR) on a magnetic ink character recognition (MICR) line to obtain said routing number and said account number.

4. The system of claim 1 wherein:
said funding accounts are direct deposit accounts; and
said first organization and said second organization comprise financial institutions.

5. The system of claim 1 wherein said processing said transaction comprises performing an accounts receivable conversion (ARC), and processing an automated clearinghouse (ACH) transaction based on said ARC.

6. The system of claim 1 wherein said method further comprises configuring an external funding account using said routing number and said account number.

7. The system of claim 1 wherein said method further comprises reporting said transaction to account holder of said bill payment account when said transaction has occurred.

8. A method comprising:
generating a bill payment request associated with a bill payment account held at a first organization, said bill payment request comprising a balance due amount;
transmitting said bill payment request to a wireless computing device associated with an account holder of said bill payment account;
determining whether said account holder of said bill payment account holds a funding account at said first organization;
transmitting a request for an image of a face of a check in response to a determination that said account holder of said bill payment account does not hold said funding account at said first organization;
receiving an electronic image of said face of a check wherein said check corresponds to a funding account held at a second organization;
extracting a routing number and an account number from said electronic image; and
processing a transaction using said routing number and said account number to pay at least a portion of said balance due amount, said transaction occurring between said first organization and said second organization.

9. The method of claim 8 wherein
said electronic image is generated by said wireless communication device.

10. The method of claim 8 wherein said extracting includes using optical character recognition (OCR) on a magnetic ink character recognition (MICR) line to obtain said routing number and said account number.

11. The method of claim 8 wherein:
the funding accounts are direct deposit accounts; and
said first organization and said second organization comprise financial institutions.

12. The method of claim 8 wherein said processing said transaction comprises performing an accounts receivable conversion (ARC), and processing an automated clearinghouse (ACH) transaction based on said ARC.

13. The method of claim 8 wherein said method further comprises configuring an external funding account using said routing number and said account number.

14. The method of claim 8 wherein said method further comprises reporting said transaction to account holder of said bill payment account when said transaction has occurred.

15. A non-transitory computer-readable storage media having stored thereon, a computer program having at least one code section for processing data, said at least one code section being executable by a processor of a computing device for causing said computing device to perform:
generating a bill payment request associated with a bill payment account held at a first organization, said bill payment request comprising a balance due amount;
transmitting said bill payment request to a wireless computing device associated with an account holder of said bill payment account;
determining whether said account holder of said bill payment account holds a funding account at said first organization;
transmitting a request for an image of a face of a check in response to a determination that said account holder of said bill payment account does not hold said funding account at said first organization;
receiving an electronic image of said face of a check wherein said check corresponds to a funding account held at a second organization;
extracting a routing number and an account number from said electronic image; and
processing a transaction using said routing number and said account number to pay at least a portion of said balance due amount, said transaction occurring between said first organization and said second organization.

16. The non-transitory computer-readable storage media of claim 15, wherein
said electronic image is generated by said wireless communication device.

17. The non-transitory computer-readable storage media of claim 15 wherein said extracting includes using optical character recognition (OCR) on a magnetic ink character recognition (MICR) line to obtain said routing number and said account number.

18. The non-transitory computer-readable storage media of claim 15 wherein:
said funding accounts are direct deposit accounts; and
said first organization and said second organization comprise financial institutions.

19. The non-transitory computer-readable storage media of claim 15 wherein said processing said transaction comprises performing an accounts receivable conversion (ARC), and processing an automated clearinghouse (ACH) transaction based on said ARC.

20. The non-transitory computer-readable storage media of claim 15 wherein said at least one code section being executable by a processor of a computing device further causes said computing device to further perform:
reprocessing said electronic image for a second bill payment request generated subsequent to said bill payment request, said second bill payment request comprising a second balance due amount;
re-extracting said routing number and said account number from said electronic image; and
processing a second transaction using said routing number and said account number to pay at least a portion of said second balance due amount, said second transaction occurring between said first organization and said second organization.
